(19) United States
(12) Patent Application Publication
(10) Pub. No.: US 2020/0198204 A1
(43) Pub. Date: Jun. 25, 2020

(54) EXTRUSION APPARATUS FOR PRODUCING AN EDGE GUARD FOR FLOOR COVERINGS

(71) Applicant: Tarkett USA Inc., Solon, OH (US)

(72) Inventor: Curt Johnston, Chagrin Falls, OH (US)

(73) Assignee: Tarkett USA Inc., Solon, OH (US)

(21) Appl. No.: 16/805,998

(22) Filed: Mar. 2, 2020

Related U.S. Application Data
(63) Continuation-in-part of application No. 16/004,938, filed on Jun. 11, 2018, now Pat. No. 10,619,360.
(60) Provisional application No. 62/517,448, filed on Jun. 9, 2017.

(51) Int. Cl. B29C 48/12; B29C 48/305; A47G 27/04

(52) U.S. Cl. CPC B29C 48/12; B29K 2027/06; A47G 27/045; B29C 48/305

(57) ABSTRACT

An extrusion apparatus for extruding an edge guard for flooring products or the like, which apparatus includes an extrusion die for simultaneously extruding at least two components simultaneously, such as stripes of alternating colors for a visible part of the edge guard, to render the striped part of the edge guard visible to persons crossing the edge guard.

### CROSS-REFERENCE TO RELATED APPLICATION

This application is a continuation-in-part of U.S. application Ser. No. 16/004,938 filed on Jun. 11, 2018 and entitled ‘EDGE GUARD FOR AREA RUG” which claims priority on U.S. Provisional Application Ser. No. 62/517,448 filed on Jun. 9, 2017, entitled “EDGE GUARD FOR AREA RUG.” The entirety of the above-noted applications are incorporated by reference herein.

### BACKGROUND OF THE INVENTION

### Field of the Invention

This invention relates to edge guards respectively having, in particular, transitions between a rug or carpet and a subfloor or floor, and more specifically to an area rug for transitioning to zero tolerance (the subfloor). The invention further relates more specifically to an extrusion die mold, and in particular to an extrusion die mold for two different extrusion components simultaneously molded. The invention further relates to a method of extrusion molding of flooring apparatus and the like, having more than one extruded component being molded at the same time.

### Description of the Prior Art

There are a number of patent publications directed to borders for floor coverings which relate in a general way to the subject matter of the present application. U.S. Pat. No. 4,054,698 (Hamrah 1977) discloses a carpet binding tape with a body for holding the edge of a carpet to the floor upon which the carpet is placed, and a curved flanged portion overhanging the body. Another edge strip is disclosed in U.S. Pat. No. 5,706,623 (Brown 1998) which discloses a carpet edge strip made from an aluminum extrusion that includes a flat strip attached to a floor with an upstanding rib. A cap fits over the strip which has a nose portion for receiving the upstanding rib. In U.S. Pub. 2008/0313850 published Dec. 25, 2008, a carpet attachment fixture operates as a common tack strip for securing the edge of the carpet in place and as a terminal decorative strip mating with a base molding, a floor surface and a raised floor surface. The elements are flexible for admitting the carpet edge to fit between opposing edges while compressively gripping the carpet that was inserted. A floor mat assembly is disclosed in U.S. Pat. No. 8,298,642 (Yuan et al. 2012). In U.S. Pat. No. 10,173,351 (Mooney et al. 2019) an airline carpet kit is disclosed that uses an edge forming die. Referring to Japanese Patent 6413797, a lightweight floor mat is disclosed. It is made by molding, but not an extrusion molding of two different extrudates. Turning to UK Patent 2,341,795 (Jaques 2000), an extruded carpet edge protector is positioned adjacent a skirting and floorboards, and receives a carpet gripper to prevent the carpet edge from being soiled by virtue of its stopping sooty air from flowing between the skirting and the floorboards. In Korean Patent Application 20000007092, a scaffold for shoe hair is placed at the entrance of a building. It comprises a frame material surrounding a carpet, wherein the frame is made from rubber or PVC resin which only covers part of the carpet. This carpet is used for the interior flooring of a car. In Japanese Patent Application 2001275819 a peripheral frame is disclosed for carpet laying that protects the peripheral portion of the carpet to prevent tripping at the end of the carpet. In Japanese Patent Application 2001275819, a peripheral frame is disclosed which is molded using a die wheel and not an extrusion apparatus as is disclosed for the present invention. The peripheral frame that is disclosed in this invention is made of a band-shaped substrate and a peripheral platform that projects from the substrate to its surface and has a downward slope. A protruding piece is upright and a number of engaging elements are provided upright on the substrate to form an engaging portion. The peripheral edge of the carpet is laid on the floor, and the peripheral frame protects the floor and there is no step between the carpet and the floor. None of the foregoing disclosures relate to an extrusion apparatus which is the subject of the invention disclosed in the present application.

### SUMMARY OF THE INVENTION

An object of the present invention is the provision an extrusion molding apparatus for simultaneously molding two different PVC or other plastic forming integral parts of a single final flooring product and the like, and the method for conducting such an extrusion procedure.

Another object is to provide a molding apparatus as described above, which is effective, efficient and reliable in use.

### BRIEF DESCRIPTION OF THE DRAWINGS

FIG. 1 is a transition published by the Access Board of the ADA.

FIG. 2 is another transition published by the Access Board of the ADA.

FIG. 3 is a perspective view of an edge guard comprising a transition for use with a rug according to a preferred embodiment of the invention.

FIG. 4 is a partial, perspective view of the edge guard shown in FIG. 3 of an edge guard according to a preferred embodiment of the invention on a supply roll for storage of such edge guards.

FIGS. 5 and 6 are respectively a side view and a top view of an edge guard according to a preferred embodiment of the invention in which a carpet has been installed.

FIG. 6A is a top view of the edge guard shown in FIGS. 5 and 6 without a carpet having been installed thereon.

FIG. 7 is another perspective view of the edge guard on a supply roll as shown in FIG. 4.

FIG. 8 is a partial perspective view of an edge guard according to a preferred embodiment of the invention.

FIG. 9 is a partial side view of an edge guard according to a preferred embodiment of the invention.

FIGS. 10 and 11 are side views of two different sizes of edge guards according to a preferred embodiment of the invention.

FIG. 12 is a partial side view of an edge guard according to a preferred embodiment of the invention having a different configuration from that shown in FIG. 9.

FIG. 13 is a side view of an edge guard according to a preferred embodiment of the invention having a different configuration from that shown in FIGS. 10, 13 and 14.

FIG. 14 is a side view of an edge guard according to a preferred embodiment of the invention having a different configuration from those shown in FIGS. 10, 11 and 13.

FIG. 15 is a top view of a set of edge guards framing an area rug.

FIG. 16 is a perspective view of the entry side of a front die plate for use in molding an edge guard according to a preferred embodiment of the invention.

FIG. 17 is a perspective rear view of the exit side of the front plate of a die block for molding an edge guard according to a preferred embodiment of the invention.

FIG. 18 is a perspective view of the entry side of a back plate of a die block for molding an edge guard according to a preferred embodiment of the invention.

FIG. 19 is a perspective view of the exit side of a back plate of a die block for molding an edge guard according to a preferred embodiment of the invention.

FIG. 20 is a perspective view of a complete extrusion die mold, showing the front plate and the back plate attached together as a complete die block.

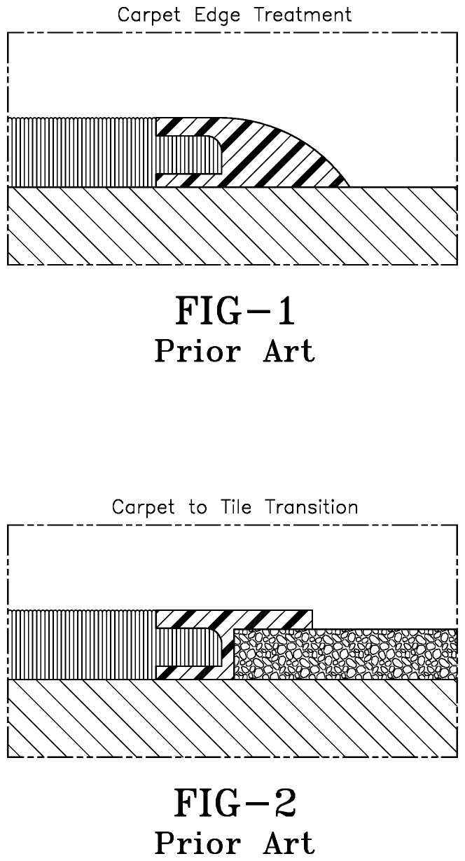

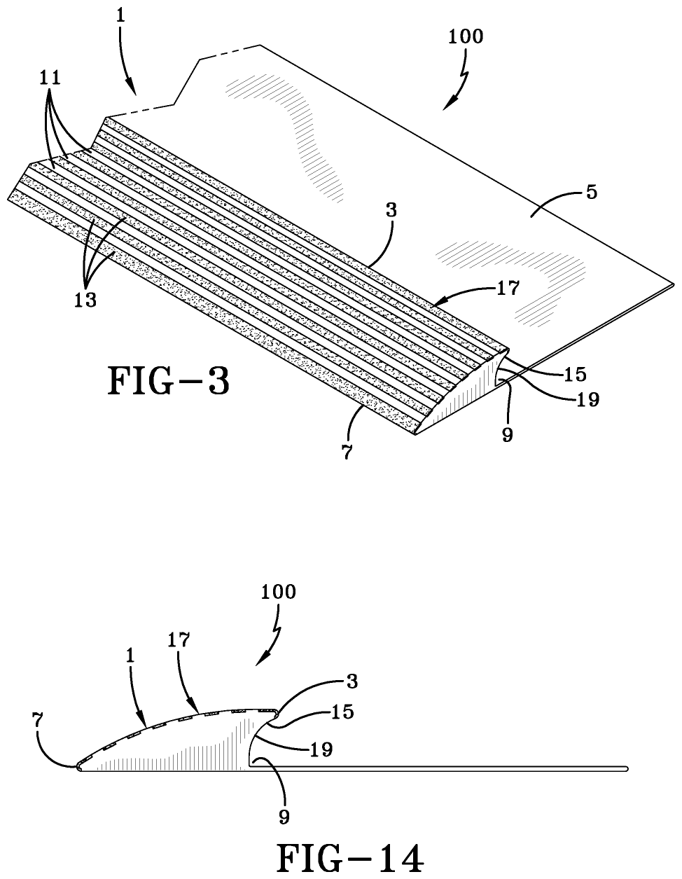

### DESCRIPTION OF THE PREFERRED EMBODIMENTS

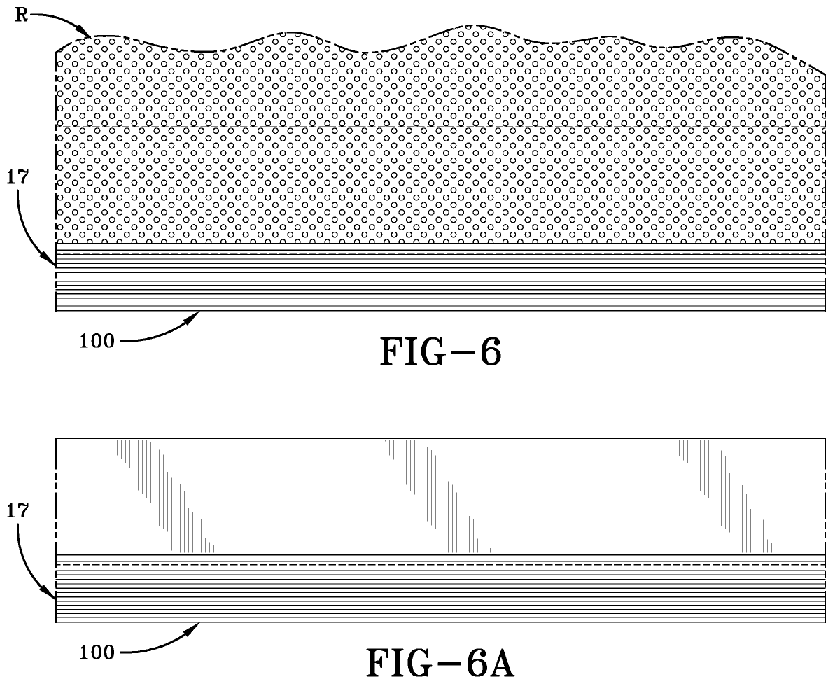

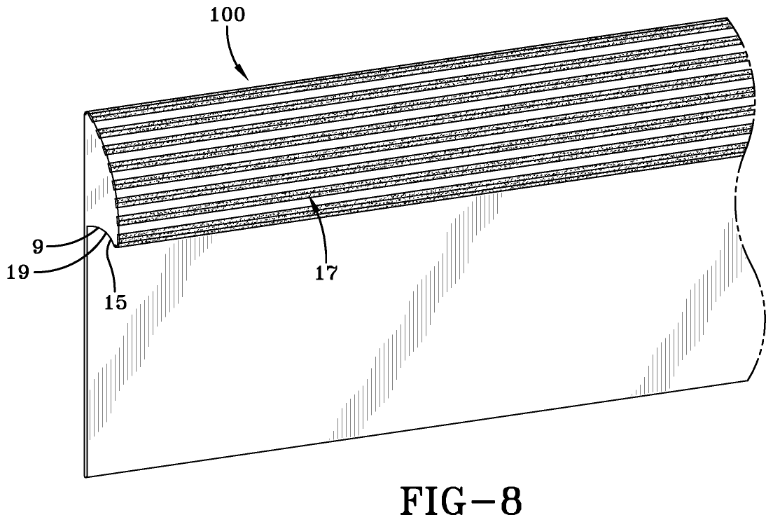

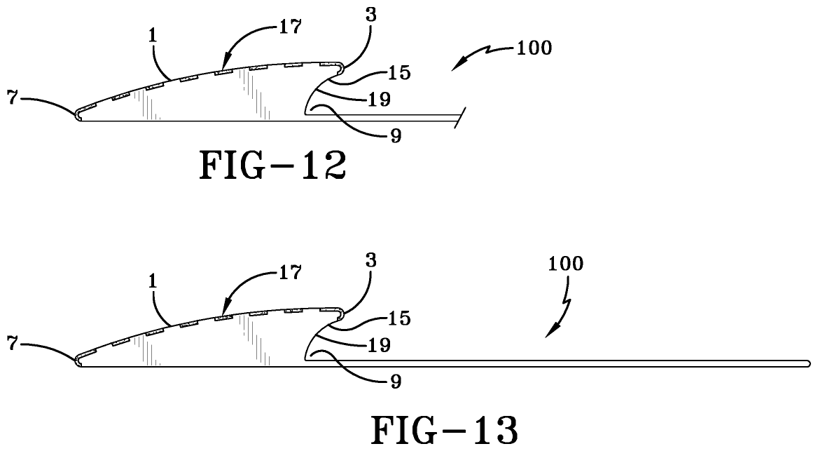

An edge guard 100 comprising a transition 1 for floor covering including a vinyl tile and carpet tile is shown in each of FIGS. 3-6, 6A and 7-15.

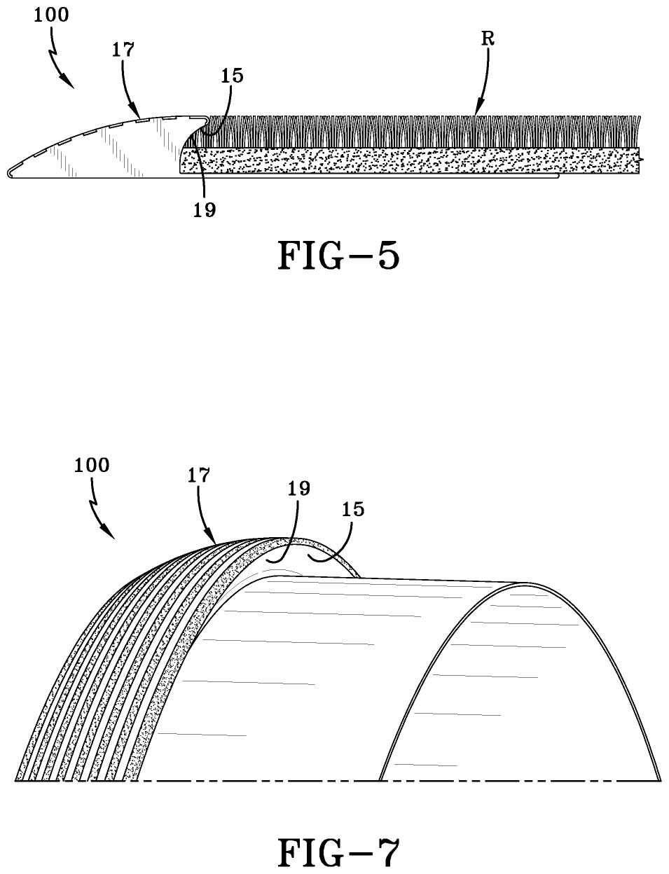

FIG. 3 is a perspective view of edge guard 100. Edge guard 100 comprises a transition 1 which includes a lip 3 on an upstanding free end of transition 1. A glue strip 5 extends from a toe 7 of transition 1 which is at a juxtaposition the base of transition 1 and the top surface of transition 1. A receiver 9 is located between transition 1 and glue strip 5 for receiving the edge of floor covering such as a rug, tile, carpet tile and vinyl tile. Transition 1 is essentially a partial flattened egg shaped or partial, flattened ovoid as shown most clearly in FIGS. 5 and 9-14 discussed below.

A series of parallel stripes 11, 13 extend horizontally across the top of transition 1. Stripes 11 and 13 are contrasting in color relative to each other and are preferably coextruded along with the extrusion process used to form edge guard 100 as described hereinafter. Stripes 13 are a portion of the material from which the balance (other than stripes 11) are made. The latter material is preferably flexible polyvinyl chloride (“PVC”), and the colors can be arbitrarily selected. Stripes 11, 13 can be solely aesthetic, but also could serve as a warning of the presence, change in elevation and location of the edge guard 100.

Although stripes 11, 13 can be part of a smooth surface, one color stripe may be slightly raised over the adjacent stripe(s). That is, stripes 11 and 13 can be alternately raised and lowered relative to respective adjacent stripes. However, this makes no difference in the functioning of edge guard 100, but can be aesthetically pleasing and can warn pedestrians of the presence of transitions 1.

A rug R or other floor covering is installed in receiver 9 when edge guard 100 is in use. As explained below, rug R is held firmly in place by lip 3 so that rug R cannot slip out of receiver 9 and dirt cannot move between rug R and receiver 9.

One way of securing rug R to edge guard 100 is by the use of an appropriate adhesive that is used to cover all or part of glue strip 5. A preferable adhesive is product #945. Product #945 is a proprietary product of Tarkett USA Inc. This product #945 is a nonflammable, solvent free, neoprene latex based contact adhesive. It produces a high-strength, water resistant bond immediately upon contact. This product #945 contains no hazardous or carcinogenic ingredients defined by OSHA, federal or state agencies.

Other glues having desired characteristics can be used. Contact adhesive tapes as appropriate can be employed as well. The glue could also be applied to the underside of the rug or tile provided a firm and durable adhesive of the rug or tile to the glue strip is obtained. Reference should be made to the product installation and warranty instructions.

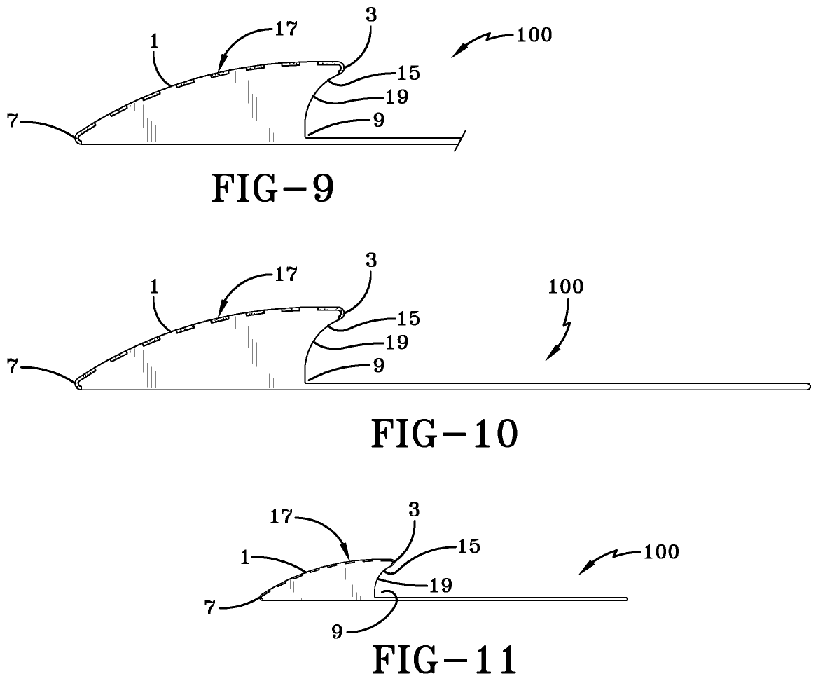

FIGS. 9-14 are side views of preferred embodiments of edge guard 100. The same identification numbers are used even though some of the dimensions are changed between the different preferred embodiments. Lip 3 is dimensioned so that if edge guard 100 is used with a carpet tile, the carpet tile pushes upwardly on the lip to prevent a person's toe from sliding under the lip to prevent tripping or stumbling. If a tile is used with edge guard 100, lip 3 bites into the tile to prevent dirt from going between the tile and the lip to prevent tripping or stumbling. There is zero tolerance at toe 7 and the subfloor to avoid a trip hazard.

There is a rounded upper surface on an upper portion or taper 15 on transition 1 forming the upper part of receiver 9. This causes tiles to bite into the top of receiver 9. This rounded upper surface or taper 15 also affects the firm gripping of rug fibers to avoid the tripping hazard discussed earlier. Taper 15 prevents the fracturing thereof.

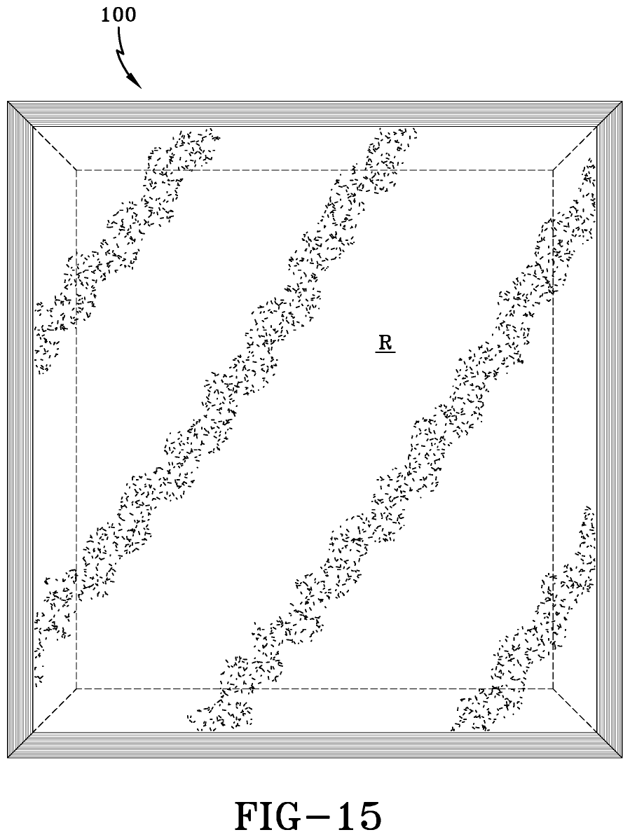

Edge guard 100 can be used to frame an area rug. Referring to FIG. 15, a set of four edge guards 100 are mitered and joined at seams or intersections 16 to form a frame 17. Seams 16 are preferably attached to each other by adhesive tape or a glue as discussed above. Edge guards could be arranged in any way to frame a rug of any type.

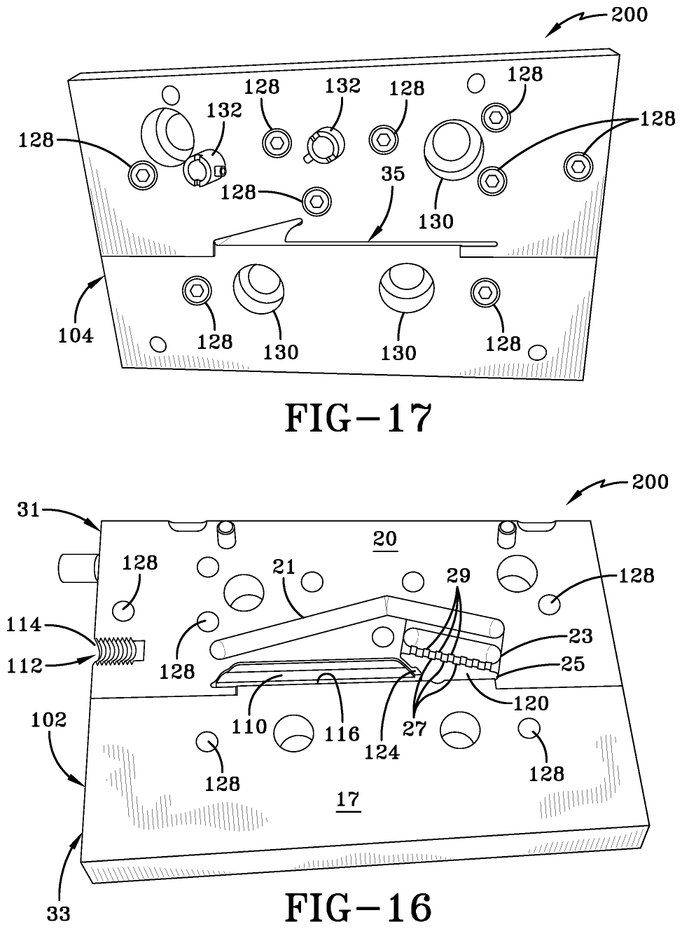

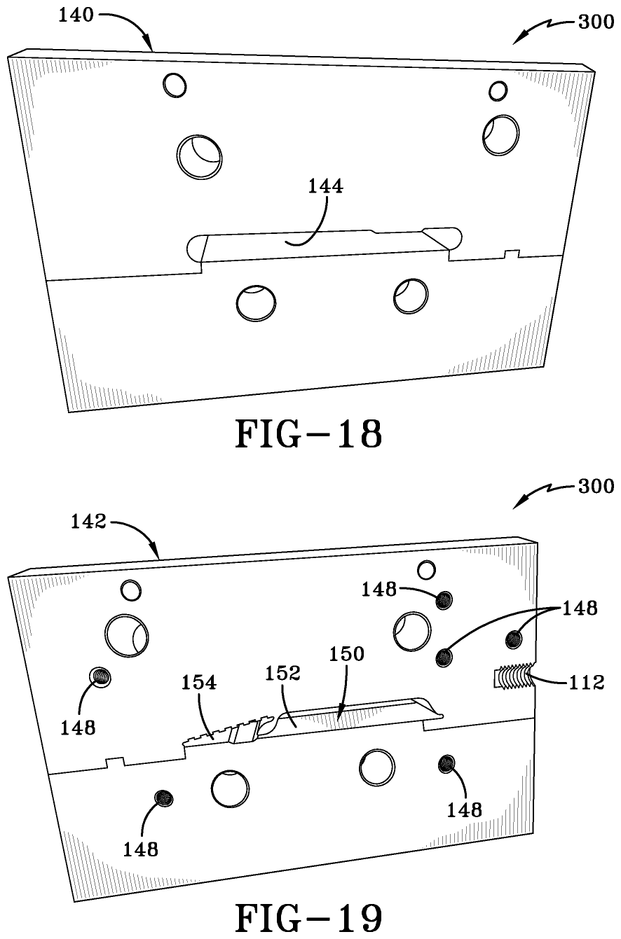

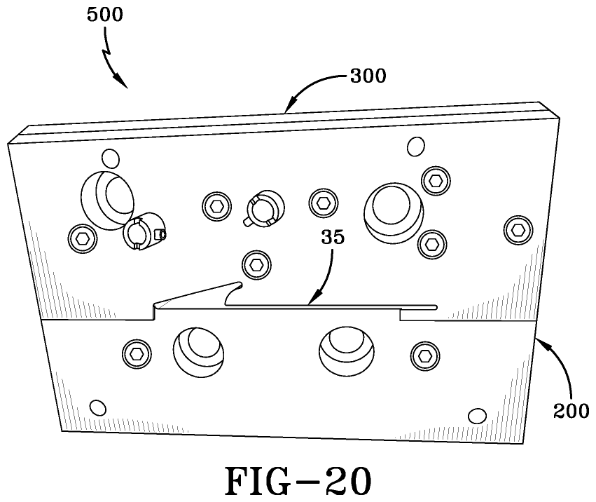

Edge guard 100 is preferably manufactured using conventional extrusion equipment with a special die apparatus. The PVC is heated in the extrusion apparatus, and the extruded material first flows through a back die plate 300. This is shown in FIGS. 18 and 19. FIG. 18 is the entry side 140 of a back die plate 300, and FIG. 19 is an exit side 142 of back die plate 300. Entry side 140 includes an entrance port 144 into which a main extrudate enters back die plate 300. Back die plate 300 cooperates with front die plate 200 to form an extrusion die mold 500 shown in FIG. 20 for making an edge guard 100 discussed above. An exit port 150 is shown in FIG. 19. Molten extrudate is fed through entrance port 144 which proceeds through to a main exit port 150, through its passageway components 152 leading to entry port 110 of front die plate 200. Thereafter, the extrudate flows through a front die plate 200, after flowing through an extruder adapter to a die front plate 200 shown in FIG. 16. Front die plate 200 cooperates with a back die plate 300 for making a complete die block or extrusion die 500 shown in FIG. 20. Front die plate 200 has a coextruded feed channel 21 and an extension feed channel 23. A small dam 25 extends between feed channel 21 and extension feed channel 23. In order to coextrude stripes 11, 13, there are alternating recesses 27 and raised portions 29. Raised portions 29 are for the black (assuming the main extrusion material is black) extrusion material and recessed portions 27 are for the lighter colored secondary extrusion material. The secondary extrusion material is a top coat on the underlying material of transition 1.

FIG. 16 illustrates an entry side 102 of front die plate 200 of extrusion die 500. FIG. 17 shows an exit side 104 of front die plate 200. Front die plate 200 works with back die plate 300 (described below) through which PVC or other extrudate flows into front die plate 200. Front die plate 200 is composed of front plate top 31 and front plate bottom 33.

FIG. 17 illustrates a front view of front die plate 300. Front die plate 200 has an outlet port 35 showing the final shape of edge guard 100. Outlet port 35 is larger than edge guard 100 being molded thereby because the molded part proceeds through a draw-back process as edge guard shrinks after it is extruded through outlet port 35.

As explained above, FIG. 17 shows exit side 104 of front die plate 200, and the left hand portion of the entry side of front die plate 200 shown in FIG. 16 would be on the opposite right hand side of front die plate 200 in FIG. 17. In other words, one would flip front die plate 200 showing entry side 102 on its right edge to show exit side 104.

In other words, the entry side of front die plate 200 is the initial part of front die plate 200 where molten PVC or other plastic flows into front die plate 200. This includes a primary entry port 110 through which the molten PVC or other plastic flows for ultimately forming glue strip 5, and coextruded feed channel 21 for receiving a second molten PVC or the other plastic from an inlet side channel 112 from a secondary extruder. The second molten PVC or other plastic has a different color than a primary molten PVC or other plastic being extruded into primary entry port 110. The secondary plastic has an inlet extruder tube (not shown) that is inserted into an outlet open end 114 of channel 112.

Molten PVC or other extruded plastic flows through entry port 110, and through several passageways. One passageway 116 leads to an exit passageway shown in FIG. 17, which has the contour of glue strip 5 of edge guard 100. Another passageway terminates in transition passageway 120 which forms transition 1, the raised body portion of edge guard 100. A protrusion 124 juts into passageway 120 shown in FIG. 16, to provide receiver 9 in edge guard 100, as also shown in FIG. 17. Thus, die component 35 has the final configuration of edge guard 100.

An important feature of front die plate 200 is the construction for extruding alternating colored stripes 11 and 13. Assuming that the main component of edge guard 100 is a black PVC or other extrudible colored plastic, and stripes 11 and 13 are alternating black and silver (for example), front die plate 200 addresses the manufacturing situation, black extrusion material flows through entry port 110 and the subsequently located extrusion channel to die outlet 35 (including into a transition cavity 120), while silver PVC or other extrusion plastic flows through side port 112. Black PVC or other black plastic flows not only into the mold portion terminating in die outlet 35, but into transition cavity 120 and into alternating raised portions 29 on opposite sides of undercuts 27 to form black stripes (or whatever color the main extrudiant is) 13.

Silver colored PVC or other extruding silver plastic flows through inlet side port 112 into coextruded feed channel 21 into extension feed channel 23. Thereafter, the silver extrudate flows through alternating recessed portions or set of undercuts 27 to form extruded silver stripes 11. Small dam 25 retains the molten black PVC or other black.

There are various attachments and holes or orifices in front plate 200. These include bolt holes 128 that are used for bolting front die plate 200 to a back plate, and a main mating hole 130 for ½ inch bolts. A pair of thermocouples 132 are provided for measuring temperature inside of front plate 200.

FIG. 20 shows extrusion die mold 500 with back die plate 300 bolted to front die plate 200 for the extrusion molding of edge guard 100. As explained earlier, the main extrudate, which could be a black material as discussed above, would enter die mold 500 through entry port 144 and proceed through exit port 35 in front die plate 200. The secondary extrudate, which would be of a different color such as a contrasting color with the extrudate entering port 144, would enter through secondary port 112 shown in the back die plate 300 in FIG. 19 and through front die plate 200 also as secondary port 112. The secondary extrudite would be molded to form stripes on transition 1.

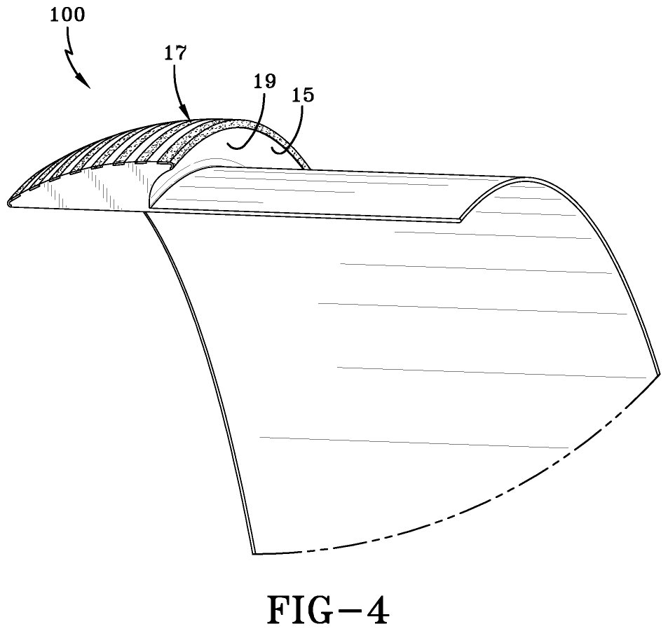

Edge guard 100 is preferably extruded and stored in twelve foot lengths. It could be extruded as a roll. From such rolls particular lengths are cut for use with selector floor coverings. It has been found that twelve foot lengths are advantageous in this regard. Portions of such rolls are shown in FIGS. 4 and 7.

The invention has been described in detail with emphasis being made to the most significant parts thereof, but variations and modifications may occur to those skilled in the art to which the invention pertains.

1. An extrusion molding apparatus for a plastic molding system for producing a final extrusion from at least a first extrudate and a second extrudate, the first extrudate and the second extrudate being in final contact with each other, the extruded part including:
the first extrudate having at least one unique characteristic, and a second extrudate having at least one second unique characteristic;
wherein said extrusion molding apparatus comprises at least one mold plate, said at least one mold plate comprising:
a first extrudate passageway for receiving the first extrudate, said first extrudate passageway comprising a first surface configuration for providing contours for receiving only the first extrudate to provide a first contour in the part being extruded, the first contour including second extrudate receptacles in the first contour for receiving respectively the second extrudate;
a second extrudate passageway for receiving only the second extrudate and placing the second extrudate in the respective second extrudate receptacles in the first contour;
wherein the extruded part comprises an exterior surface having a first extrudate portion and a second extrudate portion partially overlying and in contact with said first extrudate, the extruded part being composed respectively of the first extrudate with the first unique characteristic and the second extrudate with the second unique characteristic.

2. An extrusion mold plate according to claim 1 wherein said first surface configuration for providing contours for receiving only the first extrudate comprises a set of respectively spaced apart parallel channels, and said second extrusion passageway places the second extrudate in said respective spaced apart parallel channels in said set of the parallel respectively spaced apart channels.

3. An extrusion mold plate according to claim 2 wherein the extruded part includes a body portion, said body portion having an outer shape and comprising:
a first portion composed of the first extrudate, the first portion including a surface and a set of indentations in the surface; and
a second portion being composed of the second extrudate disposed in the respective indentations in the set indentations;
wherein said first extrusion passageway comprises:
a first extrudate inlet port for receiving the first extrudate;
a first extrudate passageway leading from said first extrudate inlet port;
a second extrudate inlet port for receiving the second extradate;
a second extrudate passageway leading from said second extrudate port;
a final passageway for receiving the first extrudate from the first extrudate passageway and the second extrudate from the second extrudate passageway;
said final passageway comprising the shape of the final part.

4. An extrusion mold plate for molding a one-piece edge guard, the edge guard being composed of an extruded relatively thick plastic transition and an extruded relatively thin glue strip extending from one flat floor engaging bottom, said extrusion mold plate comprising:
an inlet port leading to both:
a relatively thin passageway extending to a relatively thin passageway in the shape of the glue strip; and
a relatively thick passageway configured in the shape of the transition;
said relatively thick exit passageway having an upper portion, said upper portion including a set of raised, parallel portions and a set of depressed portions disposed between said raised, parallel portions to form a set of channels;
said relatively thin exit passageway and said relatively thick exit passageway discharging the respective first extrudate as part of a single edge guard;
said first relatively thin inlet port and said first relatively thick inlet port receiving a first extrudible plastic having a first color;
a second inlet port leading to a second extrusion passageway terminating in a second exit extrusion passageway comprising a set of undercuts located respectively between said set of raised parallel portions;
said second inlet port receiving a second extrudible plastic having a second color, said set of undercuts receiving a said second extrudible plastic to provide a set of alternating color extrusions on the surface of said transition.

5. A flooring product for use on a floor, said flooring product comprising:
a first extruded component including a first characteristic;
a second extruded component in operative relationship with said first extruded component, said second extruded component including a second characteristic different from said first characteristic;
wherein said first extruded component and said second extruded component cooperate to perform a function through the cooperation of said different first and second characteristics.

6. A flooring component according to claim 1 wherein said at least one unique characteristic is one color and said at least one second unique characteristic is a second color, said second color being different from said first color, said difference in colors in said first component and said second component being observable to persons viewing said flooring product.

7. A flooring product according to claim 1 wherein said first extruded component is adjacent to said second extruded component in said flooring product.

8. A flooring product according to claim 1 wherein said flooring product comprises both an underlying base portion and a surface portion, and wherein said first extruded component forms both the entirety of said underlying portion and a first part of said surface portion, and said second extruded portion forms a second part of said surface portion.

9. A flooring product according to claim 8 wherein said first part at said surface portion are in alternating first part locations on said surface portions, and second part locations between said first part locations, wherein said second extruded portions are located respectively in said second part locations.

10. An extrusion molding apparatus for a plastic molding system for producing a final extrusion from at least a first extrudate and a second extrudate, the first extrudate and the second extrudate being in final contact with each other, the extruded part including:
the first extrudate having at least one unique characteristic, and a second extrudate having at least one second unique characteristic;
wherein said extrusion molding apparatus comprises at least one mold plate, said at least one mold plate comprising:
a first extrudate passageway for receiving the first extrudate, said first extrudate passageway comprising a first surface configuration for providing contours for receiving only the first extrudate to provide a first contour in the part being extruded, the first contour including second extrudate receptacles in the first contour for receiving respectively the second extrudate;
a second extrudate passageway for receiving only the second extrudate and placing the second extrudate in the respective second extrudate receptacles in the first contour;
wherein the extruded part comprises an exterior surface having a first extrudate portion and a second extrudate portion partially overlying and in contact with said first extrudate, the extruded part being composed respectively of the first extrudate with the first unique characteristic and the second extrudate with the second unique characteristic;
and wherein said first extruded component and said second extruded component are made using extrusion molding equipment for simultaneously molding said first extruded component and said second extruded component.
